(19) United States
(12) Patent Application Publication
(10) Pub. No.: US 2015/0308185 A1
(43) Pub. Date: Oct. 29, 2015

(54) Composite Wooden Doors and Their Manufacturing Methods

(71) Applicant: Shili Zou, Qingdao (CN)

(72) Inventor: Shili Zou, Qingdao (CN)

(21) Appl. No.: 14/306,868

(22) Filed: Jun. 17, 2014

(30) Foreign Application Priority Data
Apr. 29, 2014 (CN) 201410177338.4

(51) Int. Cl. E06B 3/70

(52) U.S. Cl. CPC E06B 3/7015; E06B 3/7001

(57) ABSTRACT

The present invention discloses a composite wooden door with light weight, good insulation and anti-paint-cracking performance and easiness of fabrication. The composite wooden door includes core body, panel plate and core plate. The core body includes a core frame and a hollow section which enclosed by the core frame. The core frame is composed of external frame and internal wooden line. In the inner side of the internal wooden line, there is a “T” shape step A. In the outward side of the internal wooden line, there is molding wooden line. The position of the internal wooden line and panel plate is fixed via the “T” shape step A. A manufacturing method of the composite wooden door is provided accordingly.

### CROSS-REFERENCES TO RELATED APPLICATIONS

The present application claims priority under the Paris Convention to Chinese application number CN 201410177338.4 which filed on Apr. 29, 2014, the disclosure of which is herewith incorporated by reference in its entirety.

### TECHNICAL FIELD

The present invention belongs to the technical field of architecture decoration wooden door structure, which includes of a kind of anti-cracking and easily-fabricated composite wooden door and its manufacturing method.

### BACKGROUND OF THE INVENTION

The wooden doors on the market for sale are mainly of the following structure: A frame is composed of transverse beams and vertical beams, with core plate or glass installed within the frame—Grooves are engraved within both the transverse beams and vertical beams, the core plate or glass is installed into the frame via the grooves to assemble an integrated wooden door, which will go through the surface paint treatment. However, due to the changes of the temperature and humidity of the surroundings where the door is used or machined, the wood materials of the door will expand with heat and contract with cold. Therefore the paint around the contact area of the transverse beams and vertical beams tends to spilt, commonly known as “crack the paint”, thus seriously affecting the quality and perfection of the wooden door, particularly doors with white paint.

The utility model patent CN 201284605 Y discloses a kind of solid wooden door, which is composed of a door frame and core plate installed in the door frame. The door frame is composed of left stiles and right stiles, top rails, bottom rails and middle rails. It characterizes as: the core plate, left stiles and right stiles, top rails, bottom rails and middle rails aforementioned are all composite wood structure. All composite wood mentioned here are fabricated by a frame and two board through hot-press gluing, and the frame is composed of two door edges and several transverse beams.

The invention model patent CN 103362411 A disclosed a kind of anti-surface-cracking composite door, which features as: it includes a core mechanism and two panel plates which match the core mechanism in terms of size and shape. The panel plate is an integrative structure, on which a hollow-out part is made. The panel plate and core mechanism are fixed jointly. The core mechanism includes an exposed core panel, fixing frame, door frame and lock wood block. The core plate is installed in the inside of the fixing frame. The fixing fame is fixed within the door frame to make the core plate to be located at the hollow-out part of the panel plate. The lock wood block is installed in the gap between the fixing frame and the door frame.

### BRIEF SUMMARY OF EMBODIMENTS OF THE INVENTION

In order to solve the prior technical problems, the invention discloses a composite wooden door with a light weight, good insulation and anti-paint-cracking performance and easiness of fabrication, as well as its fabrication method.

The technical scheme of the invention is as below: a composite wooden door, which includes core body, panel plate and core plate. The core body includes a core frame and a hollow section which enclosed by the core frame. The core frame is composed of external frame and internal wooden line. In the inner side of the internal wooden line, there is a “T” shape step A. In the outward side of the internal wooden line, there is molding wooden line. The position of the internal wooden line and panel plate is fixed via the “T” shape step A.

The core plate mentioned is installed in the hollow section. And there is hollow-out section in the panel plate. The shape of panel plate matches that of the core body; the shape of the hollow-out section matches that of the hollow section.

The hollow section is a hollow-out structure with the shape of triangle, rectangle, square, rounded rectangle or circle, or a combination of several shapes. Except for the shapes aforementioned, the hollow section can also be a decorative hollow-out structure of regular or irregular shapes.

The core frame is composed of left stiles, right stiles, top rails and bottom rails.

The core fame not only includes the left stiles, right stiles, top rails and bottom rails, but also transverse beams and/or vertical beams.

The hollow structure, which formed by external frame and internal wooden line, stuffed with the filling part. The filling part shall be filled with foam materials, honeycomb paper, solid wood, shaving board or MDF (medium density fiberboard). The external frame is made of solid wood or MDF (medium density fiberboard). The internal wooden line is made of solid wood or MDF (medium density fiberboard).

There are grooves set in the outward side of the internal wooden line. The width of the grooves matches the core plate installed in the hollow section. The core plate is inserted into the grooves. The core plate is made of glass, MDF (medium density fiberboard), solid wood, shaving board, plywood, composite board, acrylic or other high polymer material.

Lock wood block is set in left stiles and/or right stiles. The lock wood block is used for lock installation for the door.

A manufacturing method of the composite wooden door above-mentioned, which includes the following steps:

1), Fabricate the core frame, and insert the core plate into the grooves of the internal wooden line of the core frame.

2), Install the lock wood block into the hollow structure of the left stiles and/or right stiles of the core frame. And fill the filling part stuff into the hollow structure which formed by the external frame and internal wooden line of the core frame.

3), Fabricate panel plate in accordance with the shape of the core body. A margin of 1-5 mm shall be left at the outward side of the panel plate.

4), Fix the panel plate at the position of the “T” shape step A of the internal wooden line, and connect it with the core body in a firm way. Mill the edge of the outward side of the panel plate as per the size of the core body, thus matching the panel plate and the core body completely.

The panel plate and the core body shall be connected with the method of cold bonding, hot boding or gluing.

A composite wooden door is composed of core body, panel plate, core plate, and muntin bar. The core body includes the core frame and the hollow section which enclosed by core frames. The core frames includes external frame and internal wooden line. There is a “T shape step B is set respectively on both the top side and bottom side of the muntin bar. The “T shape step B is higher than the internal wooden line. The panel plate is located via the “T shape step B.

The core plate mentioned is installed in the hollow section. There is hollow-out section set on the panel plate. The shape of the panel plate matches that of the core body; the shape of hollow-out section matches that of the hollow section.

The hollow section is a hollow-out structure with the shape of triangle, rectangle, square, rounded rectangle or circle, or a combination of several shapes. Except for the shapes aforementioned, the hollow section can also be a decorative hollow-out structure of regular or irregular shapes.

The core frame is composed of left stiles, right stiles, top rails and bottom rails.

The core fame not only includes the left stiles, right stiles, top rails and bottom rails, but also transverse beams and/or vertical beams.

The hollow structure, which formed by external frame and internal wooden line, stuffed with the filling part. The filling part shall be filled with foam materials, honeycomb paper, solid wood, shaving board or MDF (medium density fiberboard). The external frame is made of solid wood or MDF (medium density fiberboard). The internal wooden line is made of solid wood or MDF (medium density fiberboard).

There are grooves set in the outward side of the internal wooden line. The width of the grooves matches the core plate installed in the hollow section. The core plate is inserted into the grooves. The core plate is made of glass, MDF (medium density fiberboard), solid wood, shaving board, plywood, composite board, acrylic or other high polymer material.

The muntin bar includes both transverse muntin bars and vertical muntin bars. There are connecting plugs set on both ends of the transverse muntin bars and vertical muntin bars. The vertical muntin bars are inserted into the grooves of the internal wooden lines of both the top ends and bottom ends of the hollow section via the plugs; while one end of the transverse muntin bar is inserted into the grooves of the internal wooden line on the edge of the hollow section, the other end is inserted into the grooves of the vertical muntin bar. The muntin bar is made of solid wood or MDF (medium density fiberboard).

Lock wood block is set in left stiles and/or right stiles. The lock wood block is used for lock installation for the door.

A manufacturing method of the composite wooden door above-mentioned, which includes the following steps:

1) Fabricate the core frame, and insert the core plate into the grooves of the internal wooden line of the core frame.

2) Install the lock wood block into the hollow structure of the left stiles and/or right stiles of the core frame. And fill the filling part stuff into the hollow structure which formed by the external frame and internal wooden line of the core frame.

3) Insert and install the muntin bar.

4) Fabricate panel plate in accordance with the shape of the core body. A margin of 1-5 mm shall be left at the outward side of the panel plate.

5) Fix the panel plate at the position of the “T” shape step B of the muntin bar, and connect it with the core body in a firm way. Mill the edge of the outward side of the panel plate as per the size of the core body, thus matching the panel plate and the core body completely.

The panel plate and the core body shall be connected with the method of cold bonding, hot boding or gluing.

The invention has the beneficial effects as follows:

1. Compared with the traditional technique of jointing by tenons, the exposed panel plate is an integrative structure. Thus there will no potential problem of paint crack on the surface of the door.

2. There are fewer components needs to be processed. And there is a lower requirement of machining precision on the components. The processing is simple. It lays lower technical requirements on manufactures, who can work with a higher efficiency. It requires a lower manpower cost.

3. The core frame can be filled with foam materials or shaving board, which functions as insulation and moisture absorption material. Therefore it can prevent effectively the core frame from shape changing caused by the changes of humidity and temperature.

4. Margins are left in advance during panel plate fabrication, thus to ensure that the panel plate and core body matches well.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

Some of the figures included herein illustrate various embodiments of the invention from different viewing angles. Although the accompanying descriptive text may refer to such views as “top,” “bottom” or “side” views, such references are merely descriptive and do not imply or require that the invention be implemented or used in a particular spatial orientation unless explicitly stated otherwise.

FIG. 1 is the schematic illustration of the core body, according to embodiment 1 of the present invention;

FIG. 2 is the schematic illustration of the panel plate, according to embodiment 1 of the present invention;

FIG. 3 is the schematic illustration, according to embodiment 2 of the present invention;

FIG. 4 is the schematic illustration, according to embodiment 3 of the present invention;

FIG. 5 is the section view of the core frame, according to embodiments 1-3 of the present invention; the internal wooden line

FIG. 6 is the section view of the internal wooden line, according to embodiments 1-3 of the present invention;

FIG. 7 is the schematic illustration of the core body, according to embodiment 4 of the present invention;

FIG. 8 is the schematic illustration of the panel plate, according to embodiment 4 of the present invention;

FIG. 9 is the is the enlarged view of Part A of FIG. 7, according to embodiment 4 of the present invention;

FIG. 10 is the B-B direction section view of the FIG. 9, according to embodiments 4 of the present invention;

FIG. 11: is the section view of part of the core frame, according to embodiments 4 of the present invention;

FIG. 12: is the section view of part of the muntin bar, according to embodiments 4 of the present invention;

FIG. 13: is one of the schematic illustrations of the muntin bar, according to embodiments 4 of the present invention;

FIG. 14: is another of the schematic illustrations of the muntin bar, according to embodiments 4 of the present invention.

Hereinto: 1. core body; 2. panel plate; 3. core plate; 4. muntin bar; 101. core frame; 102. hollow section; 103. external frame; 104. internal wooden line; 105: “T” shape step A; 106. left stile; 107. right stile; 108. top rail; 109. bottom rail; 110. transverse beam; 111. vertical beam; 112. filling part; 113. groove; 114. lock wood block; 201. hollow-out section; 202. outward side of the panel plate; 401. “T” shape step B; 402. transverse muntin bar; 403. vertical muntin bar, 404. plug.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

From time-to-time, the present invention is described herein in terms of example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

Unless defined otherwise, all technical and scientific terms used herein have the same meaning as is commonly understood by one of ordinary skill in the art to which this invention belongs. All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this document prevails over the definition that is incorporated herein by reference.

The present invention, in some embodiments thereof, relates to Composite Wooden Doors and Their Manufacturing Methods.

### Embodiment 1

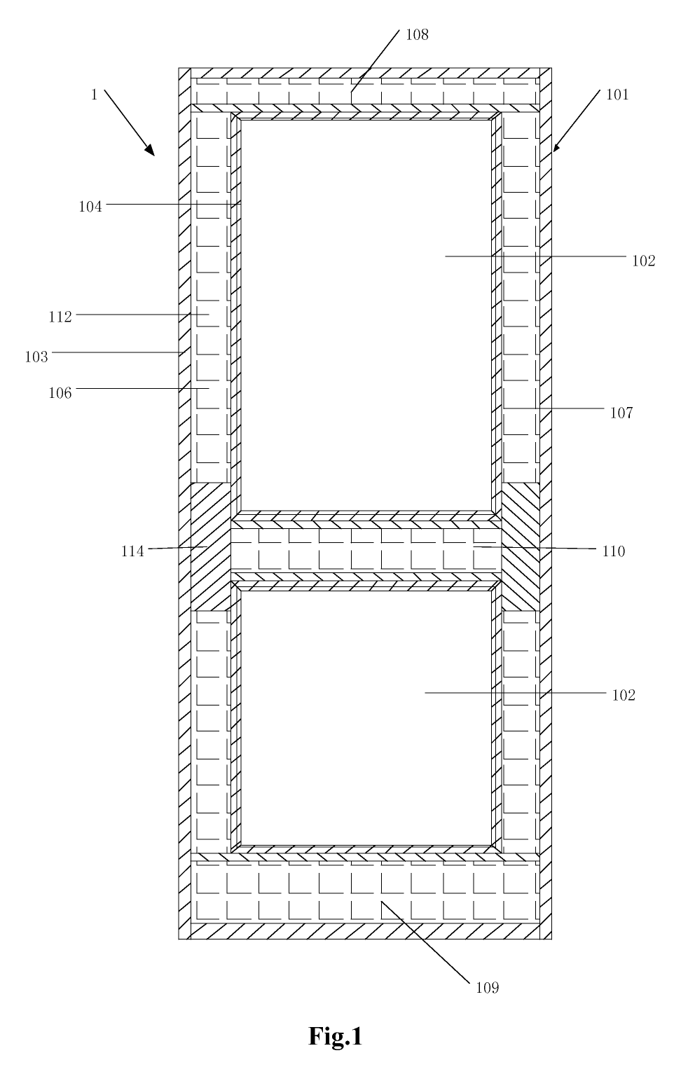

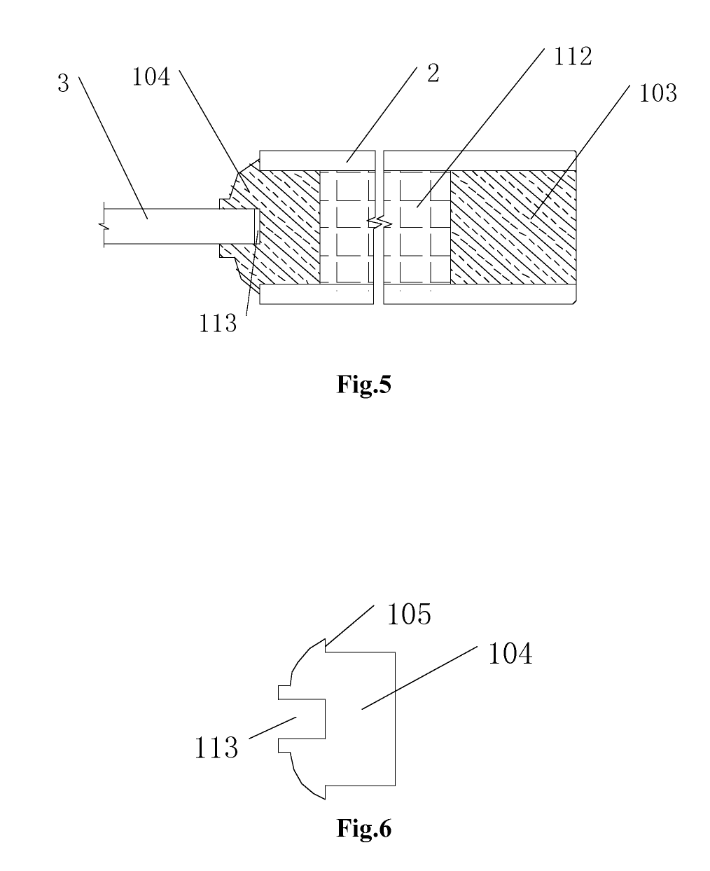

As shown in FIG. 1-2 and FIG. 5-6, a composite wooden door includes core body 1, panel plate 2 and core plate 3. The core body 1 includes a core frame 101 and a hollow section 102 which enclosed by core frame 101. The core frame 101 is composed of external frame 103 and internal wooden line 104. In the inner side of the internal wooden line 104, there is a “T” shape step A 105. In the outward side of the internal wooden line 104, there is molding wooden line. The position of internal wooden line 104 and panel plate 2 are located via the “T” shape step A 105. The core plate 3 mentioned is installed in the hollow section 102. And there is hollow-out section 201 in the panel plate 2. The shape of panel plate 2 matches that of core body 1; the shape of hollow-out section 201 matches that of hollow section 102. The hollow section 102 is a hollow-out structure composed of rectangle and square. Core frame 101 include left stile 106, right stile 107, top rail 108, bottom rail 109, and transverse beam 110. The hollow structure, which formed by external frame 103 and internal wooden line 104, stuffed with the filling part 112. The filling part 112 is made of foam materials. The external frame 103 is made of solid wood, and internal wooden line 104 is made of solid wood too. There are grooves 113 set in the outward side of the internal wooden line 104. The width of groove 113 matches the thickness of core plate 3. The core plate 3 is inserted into the groove 113. The material of core plate 3 is glass. There is lock wood block 114 on the left stile 106 and/or right stile 107.

The manufacturing method of the composite wooden door above-mentioned, which includes the following steps:

1), Fabricate core frame 101, and insert core plate 3 into groove 113 of the internal wooden line 104 of core frame 101.

2), Install the lock wood block 114 in the hollow structure of the left stile 106 and/or right stile 107 of core frame 101. Fill filling parts 112 into the hollow structure which formed by external form 103 and internal wooden line 104 of the core frame 101.

3), Fabricate panel plate 2 in accordance with the shape of core body 1. A margin of 1-5 mm shall be left at the outward side of the panel plate 202.

4), Fix panel plate 2 at the position of the “T” shape step A105 of the internal wooden line 104, and connect it to core body 1 in a firm way. Mill the edge of outward side of panel plate 202 in accordance with the size of core body 1, thus matching panel plate 2 and core body 1 in a well manner.

The panel plate 2 and core body 1 shall be connected in the approach of cold bonding or hot bonding or gluing.

### Embodiment 2

Except for the differences listed as below, others are the same as the embodiment 1.

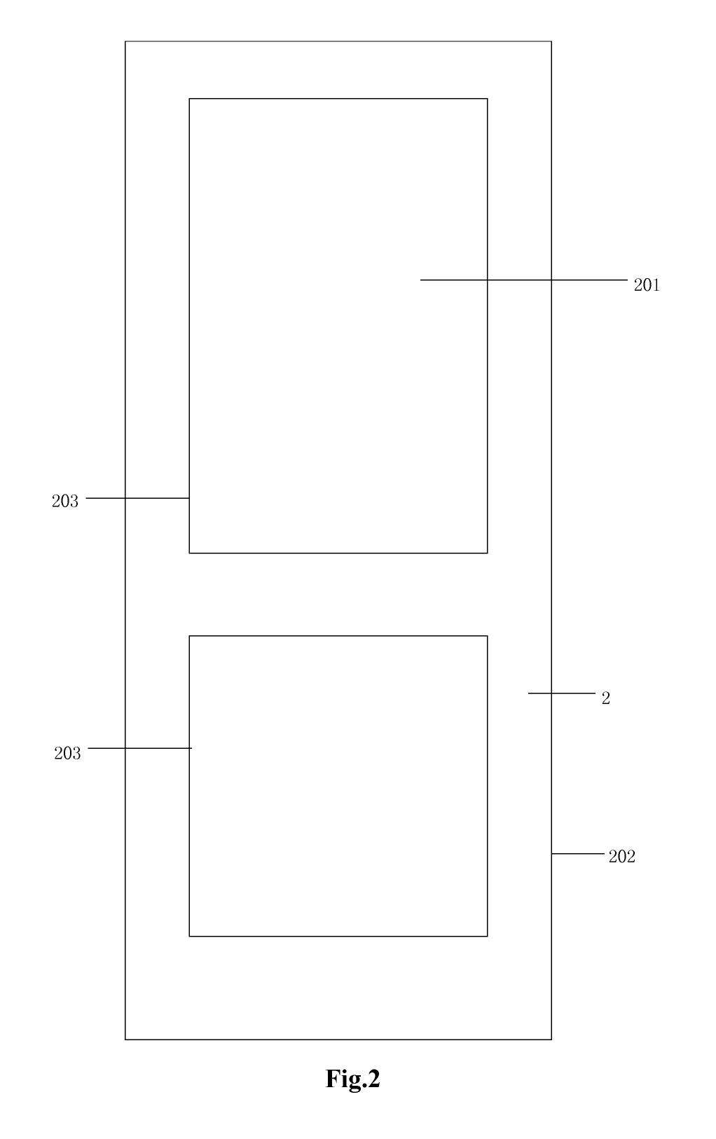

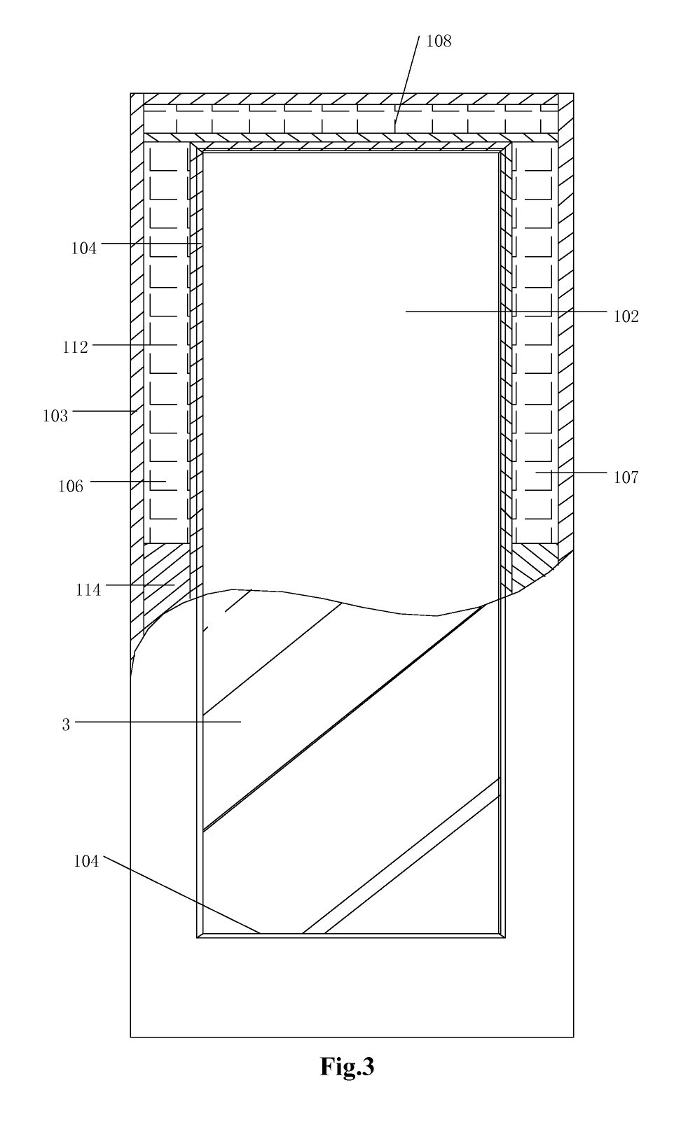

As shown in FIGS. 2, 5 and 6, the core frame 101 includes left stile 106, right stile 107, top rail 108 and bottom rail 109. The hollow-out section 201 is a hollow-out structure with the shape of rectangular.

The filling part 112 is made of honeycomb paper.

The core plate 3 is made of MDF.

### Embodiment 3

Except for the differences listed as below, others are the same as the embodiment 1.

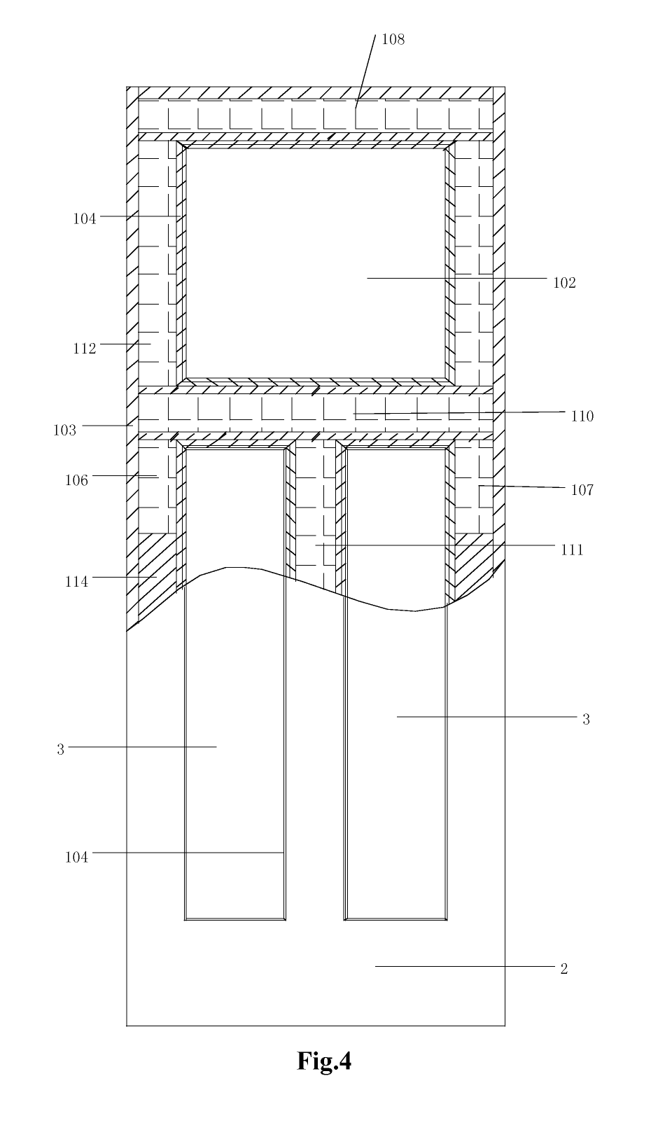

As shown in FIG. 4-6, the core frame 101 includes left stile 106, right stile 107, top rail 108, bottom rail 109, transverse beam 110 and vertical beam 111. The hollow section 102 mentioned is a hollow-out structure composed of one square and two rectangles.

The filling part 112 is made of MDF, the external frame 103 is made of solid wood, and the internal wooden line 104 is made of solid wood too.

The core plate 3 is made of shaving board.

### Embodiment 4

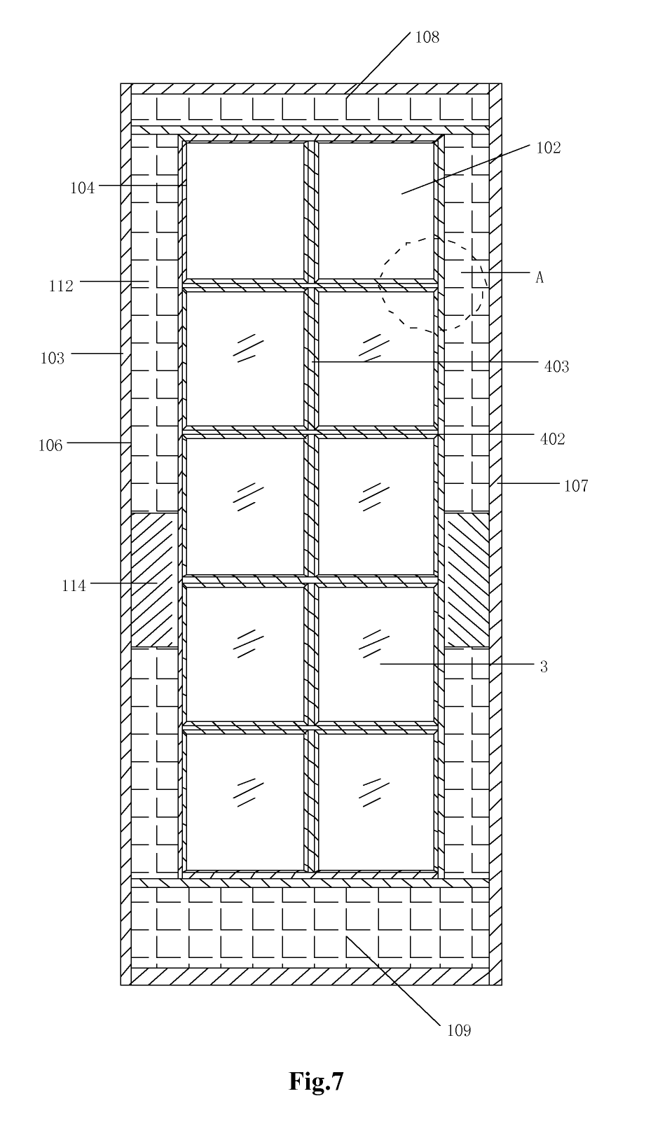

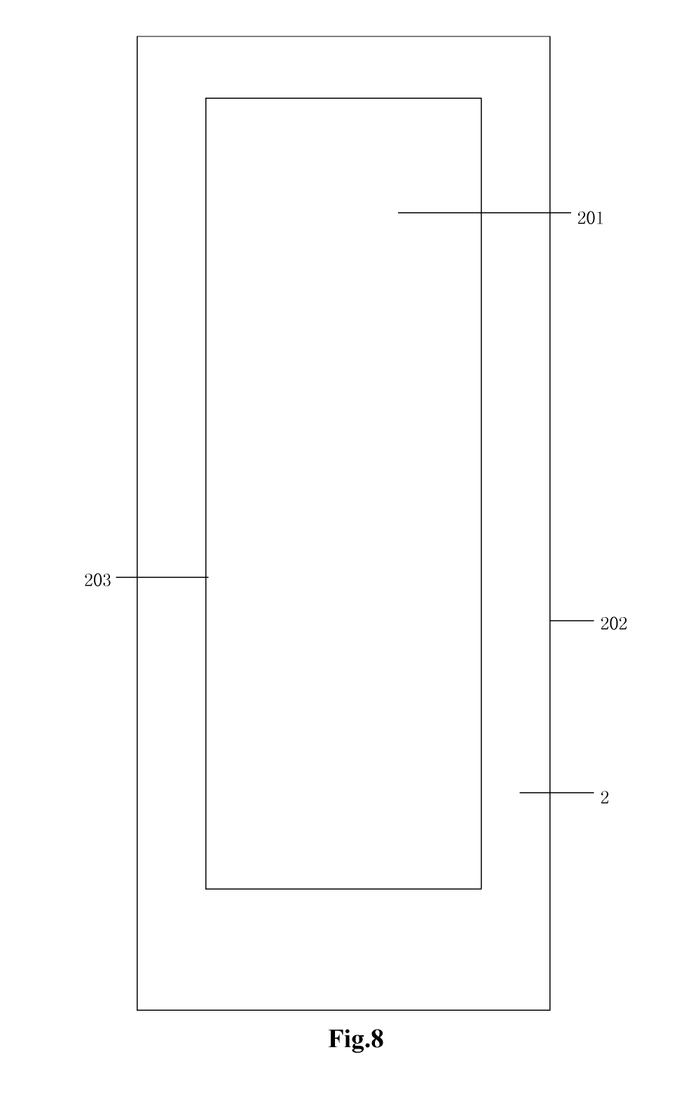

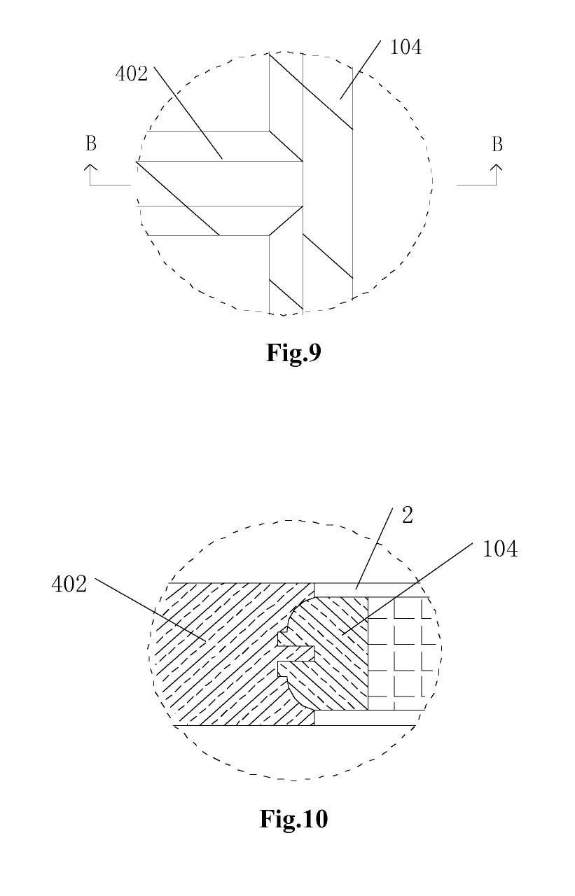

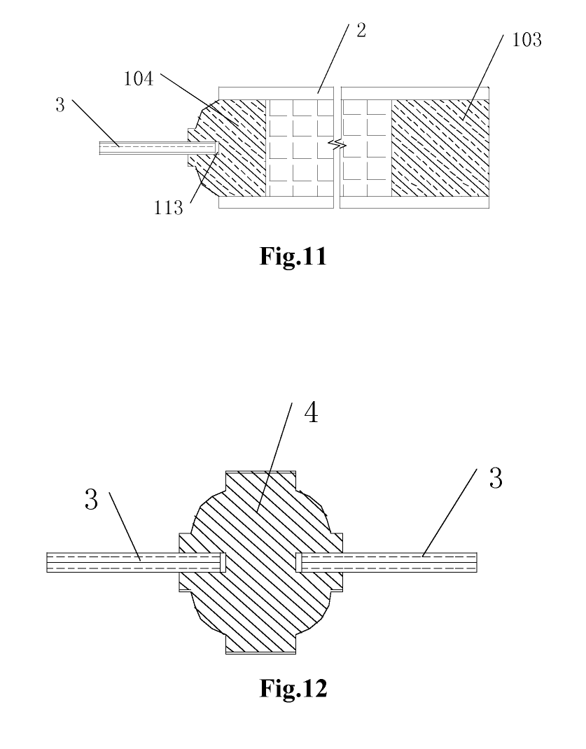

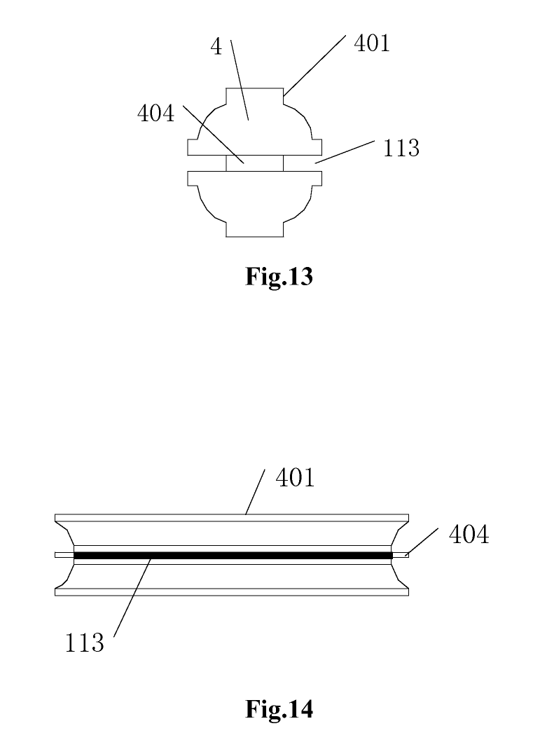

As shown in FIG. 7-14, a composite wooden door, such as glass-paneled door or French door, includes core body 1, panel plate 2, core plate 3 and muntin bar 4. The core body 1 includes a core frame 101 and a hollow section 102 which enclosed by core frame 101. The core frame 101 is composed of external frame 103 and internal wooden line 104. There is a “T shape step B 401 is set respectively on both the top side and bottom side of the muntin bar 4. The “T shape step B 401 is higher than the internal wooden line 104. The panel plate 2 is located via the “T shape step B 401. The core plate 3 is installed in the hollow section 102. There is hollow-out section 201 set on the panel plate 2. The shape of panel plate 2 matches that of core body 1; while the shape of hollow-out section 201 matches that of hollow section 102. The hollow section 102 is a hollow-out structure of rectangle. The core frame 101 includes left stile 106, right stile 107, top rail 108, bottom rail 109. Within the hollow structure which formed by external frame 103 and internal wooden line 104, there is the filling part 112. The filling part 112 is made of shaving board. The external frame 103 is made of solid wood, and the internal wooden line 104 is made of solid wood too. There are grooves set in the outward side of internal wooden line 104 and in both flank sides of muntin bar 4, the width of which shall match the core plate 3 installed in the hollow section 102. The muntin bar 4 includes transverse muntin bar 402 and vertical muntin bar 403. There are connecting plugs 404 set on both ends of transverse muntin bars 402 and vertical muntin bars 403. The vertical muntin bars 403 are inserted into the grooves 113 of the internal wooden lines 104 which are on both the top end and bottom end of the hollow section 102 via the plugs 404. While one end of transverse muntin bar 402 is inserted into the grooves 113 of the flank side of internal wooden line 104 of hollow section 102. The core plate 3 is inserted into the grooves 113 of internal wooden line 104 and muntin bar 4 based on the space which formed by the internal wooden line 104 and muntin bar 4. The material of muntin bar 4 is solid wood. The material of core plate 3 is glass or acrylic or other polymer material. On the left stile 106 and/or right stile 107, there is lock wood block 114. The lock wood block 114 is used to install the lock apparatus for the door.

The manufacturing method of the composite wooden door above-mentioned, which includes the following steps:

1), Fabricate core frame 101, and insert core plate 3 into the groove 113 of the internal wooden line 104 of core frame 101.

2), Install the lock wood block 114 in the hollow structure of the left stile 106 and/or right stile 107 of core frame 101. Fill filling parts 112 into the hollow structure which formed by external form 103 and internal wooden line 104 of the core frame 101.

3), Insert and install the muntin bar 4.

4), Fabricate the panel plate 2 as per the shape of the core body 1.

A margin of 1-5 mm shall be left for the outside edge 202 of panel plate 2.

5), Fix the panel plate 2 at the position of the “T” shape step B 401 of the muntin bar 4, and connect it with the core body 1 in a firm way. Mill the edge of the outward side of the panel plate 202 in accordance with the size of core body 1, thus matching panel plate 2 and core body 1 in a well manner.

The panel plate 2 and core body 1 shall be connected in the approach of cold bonding or hot bonding or gluing.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open United as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed across multiple locations.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A composite wooden door, comprising:
1) core body (1);
It comprising:
(a). core frame (101);
Core frame (101) includes external frame (103) and internal wooden line (104);
On the inner side of internal wooden line (104), there is “T” shape step A (105);
(b). the hollow section (102) which enclosed by the core frame (101);
2) panel plate (2);
3) core plate (3);
The internal wooden line (104) is located via “T” shape step A (105) and panel plate (2).

2. A composite wooden door of claim 1, wherein the base further comprises:
The panel plate (2) mentioned comprising hollow out section (201);
The core plate (3) mentioned is installed in the hollow section (102);
The shape of panel (2) matches that of the core body (1), and the shape of hollow out section (201) matches that of the hollow section (102).

3. A composite wooden door of claim 1, wherein the base further comprises:
The hollow section (102) mentioned is a hollow-out section in a simple shape or in the composite shape of rectangle, triangle, square, rounded rectangle or circle.

4. A composite wooden door of claim 1, wherein the base further comprises:
The core frame (101) mentioned includes left stile (106), right stile (107), top rail (108) and bottom rail (109).

5. A composite wooden door of claim 4, wherein the base further comprises:
The core frame (101) mentioned includes transverse beam (110) and/or vertical beam (111).

6. A composite wooden door of claim 1, wherein the base further comprises:
The hollow structure, which formed by external frame (103) and internal wooden line (104), stuffed with the filling part (112).

7. A composite wooden door of claim 6, wherein the base further comprises:
There are grooves (113) in the outside of the internal wooden line (104);
The width of the groove (113) matches the thickness of the core plate (3) installed in the hollow section (102);
The core plate (3) is installed in the groove (113).

8. A manufacturing method of the composite wooden door, which comprises the following steps:
1) Fabricating the core frame (101), and inserting the core plate (3) into the grooves (113) of the internal wooden line (104) of the core frame (101);
2) Installing the lock wood block (114) into the hollow structure of the left stiles (106) and/or right stiles (107) of the core frame (101); Then filling the filling part (112) stuff into the hollow structure which formed by the external frame (103) and internal wooden line (104) of the core frame (101);
3) Fabricating panel plate (2) in accordance with the shape of the core body (1); A margin of 1-5 mm shall be left at the outward side of the panel plate (202);
4) Fixing the panel plate (2) at the position of the “T” shape step A (105) of the internal wooden line (104), and connecting it with the core body (1) in a firm way; Milling the edge of the outward side of the panel plate (202) as per the size of the core body (1), thus matching the panel plate (2) and the core body (1) completely;
The structure of the composite wooden door is composed of: core body (1), panel plate (2), and core panel (3); The core body (1) includes a core frame (101) and a hollow section (102) which formed by the core frame (101); The core frame (101) is composed of external frame (103) and internal wooden line (104); In the inner side of wooden line (104), there is “T” shape step A (105); The internal wooden line (104) is located via “T” shape step A (105) and panel plate (2); The core frame (101) mentioned includes left stile (106), right stile (107), top rail (108) and bottom rail (109); The hollow structure, which formed by external frame (103) and internal wooden line (104), stuffed with the filling part (112); There are grooves (113) set in the outward side of the internal wooden line (104); The width of the groove (113) matches the thickness of the core plate (3) installed in the hollow section (102); The core plate (3) is installed in the grooves (113).

9. A composite wooden door, comprising:
1) core body (1);
It comprising:
(a). core frame (101);
Core frame (101) includes external frame (103) and internal wooden line (104);
(b). the hollow section (102) which enclosed by the core frame (101);
2) panel plate (2);
3) core plate (3);
4) muntin bar (4);
There is a “T shape step B (401) is set respectively on both the top side and bottom side of the muntin bar (4); The “T shape step B (401) is higher than the internal wooden line (104); The panel plate (2) is located via the “T shape step B (401).

10. A composite wooden door of claim 9, wherein the base further comprises:
The panel plate (2) mentioned comprising hollow out section (201);
The core plate (3) mentioned is installed in the hollow section (102);
The shape of panel (2) matches that of the core body (1), and the shape of hollow out section (201) matches that of the hollow section (102).

11. A composite wooden door of claim 9, wherein the base further comprises:
The hollow section (102) mentioned is a hollow-out section in a simple shape or in the composite shape of rectangle, triangle, square, rounded rectangle or circle.

12. A composite wooden door of claim 9, wherein the base further comprises:
The core frame (101) mentioned includes left stile (106), right stile (107), top rail (108) and bottom rail (109).

13. A composite wooden door of claim 12, wherein the base further comprises:
The core frame (101) mentioned includes transverse beam (110) and/or vertical beam (111).

14. A composite wooden door of claim 9, wherein the base further comprises:
The hollow structure, which formed by external frame (103) and internal wooden line (104), stuffed with the filling part (112).

15. A composite wooden door of claim 9, wherein the base further comprises:
There are grooves (113) set in the outward side of the internal wooden line (104) and both sides of the muntin bar (4); The width of the grooves (113) matches the core plate (3) which installed in the hollow section (102); The core plate (3) is inserted into the grooves (113).

16. A composite wooden door of claim 15, wherein the base further comprises:
The muntin bar (4) includes both transverse muntin bars (402) and vertical muntin bars (403); There are connecting plugs (404) set on both ends of the transverse muntin bars (402) and vertical muntin bars (403); The vertical muntin bars (403) are inserted into the grooves (113) of the internal wooden lines (104) of both the top ends and bottom ends of the hollow section (102) via the plugs (404); while one end of the transverse muntin bar (402) is inserted into the grooves (113) of the internal wooden line (104) on the edge of the hollow section (102), the other end is inserted into the grooves (113) of the vertical muntin bars (403).

17. A manufacturing method of the composite wooden door, which comprises the following steps:
1) Fabricating the core frame (101), and insert the core plate (3) into the grooves (113) of the internal wooden line (104) of the core frame (101);
2) Installing the lock wood block (114) into the hollow structure of the left stiles (106) and/or right stiles (107) of the core frame (101); Then filling the filling part (112) stuff into the hollow structure which formed by the external frame (103) and internal wooden line (104) of the core frame (101);
3) Inserting and installing the muntin bar (4);
4) Fabricating panel plate (2) in accordance with the shape of the core body (1); A margin of 1-5 mm shall be left at the outward side of the panel plate (202);
5) Fixing the panel plate (2) at the position of the “T” shape step B (401) of the muntin bar (4), and connecting it with the core body (1) in a firm way; Milling the edge of the outward side of the panel plate (202) as per the size of the core body (1), thus matching the panel plate (2) and the core body (1) completely;
The structure of the composite wooden door is composed of: core body (1), panel plate (2), core panel (3) and muntin bar (4); The core body (1) includes a core frame (101) and a hollow section (102) which formed by the core frame (101); The core frame (101) is composed of external frame (103) and internal wooden line (104); There is a “T shape step B (401) is set respectively on both the top side and bottom side of the muntin bar (4); The “T shape step B (401) is higher than the internal wooden line (104); The panel plate (2) is located via the “T shape step B (401); The core frame (101) mentioned includes left stile (106), right stile (107), top rail (108) and bottom rail (109); The hollow structure, which formed by external frame (103) and internal wooden line (104), stuffed with the filling part (112); There are grooves (113) set in the outward side of the internal wooden line (104) and both sides of the muntin bar (4); The width of the grooves (113) matches the core plate (3) which installed in the hollow section (102); The core plate (3) is inserted into the grooves (113); The muntin bar (4) includes both transverse muntin bars (402) and vertical muntin bars (403); There are connecting plugs (404) set on both ends of the transverse muntin bars (402) and vertical muntin bars (403); The vertical muntin bars (403) are inserted into the grooves (113) of the internal wooden lines (104) of both the top ends and bottom ends of the hollow section (102) via the plugs (404); while one end of the transverse muntin bar (402) is inserted into the grooves (113) of the internal wooden line (104) on the edge of the hollow section (102), the other end is inserted into the grooves (113) of the vertical muntin bars (403).
